(19) United States
(12) Patent Application Publication
(10) Pub. No.: US 2009/0312538 A1
(43) Pub. Date: Dec. 17, 2009

(54) PROCESS FOR THE PREPARATION OF SUCRALOSE OF HIGH PURITY

(75) Inventors: Pandurang Balwant Deshpande, Gujarat (IN); Parven Kumar Luthra, Gujarat (IN); Sanjiv Onkarsingh Tomer, Gujarat (IN); Kashyap Ravindrabhai Wadekar, Gujarat (IN); Piyush Maheshbhai Rana, Gujarat (IN); Kamlesh Shankarlal Kanzariya, Gujarat (IN)

Correspondence Address: MERCHANT & GOULD PC, P.O. BOX 2903, MINNEAPOLIS, MN, 55402-0903, US

(73) Assignee: Alembic Limited, Vadodara (IN)

(21) Appl. No.: 12/307,652

(22) PCT Filed: Oct. 19, 2006
(86) PCT No.: PCT/IN06/00428

§ 371 Date: Jan. 6, 2009

(30) Foreign Application Priority Data
Jul. 6, 2006 (IN) 1068/MUM/2006

(51) Int. Cl. C13K 13/00

(52) U.S. Cl. 536/123.13

(57) ABSTRACT

The present invention relates to an improved process for the preparation of Sucralose having purity of at least 99.6% comprising steps of
(i) dissolving substantially impure Sucralose in water
(ii) treating the solution obtained in step (i) with a partially water immiscible solvent
(iii) washing the said solvent phase obtained in step (ii) with an amount of water sufficient to remove polar impurities
(iv) crystallizing the product from partially water immiscible solvent
(v) recrystallizing the solid obtained in step (iv) from water.

### FIELD OF INVENTION

The present invention relates to an improved process for preparing Sucralose having purity of at least 99.6%. Sucralose is represented by the structural formula (I) as shown below.

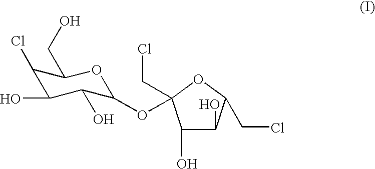

### BACKGROUND OF THE INVENTION

Sucralose is a potent sweetener having sweetness several hundred times that of sucrose. It is chemically known as 1,6-dichloro-1,6-dideoxy-β-D-fructofuranosyl-4-chloro-4-deoxy-α-galactopyranoside and having formula is C₁₂H₁₉Cl₃O₈ and molecular weight 397.64. Sucralose is used as sweetner in beverage, as coating tablet, chewing gum and other food products. It is marketed by McNeil under tradename Splenda®.

Sucralose is derived from sucrose by replacing the hydroxyl groups in the 4, 1′, and 6′ positions with chlorine. Synthesis of Sucralose is technically challenging because of the need to selectively replace specific hydroxyl groups with chlorine atoms, while preserving other hydroxyl groups including a highly reactive primary hydroxyl group. Numerous approaches to this synthesis have been developed and disclosed in U.S. Pat. Nos. 4,362,869; 4,826,962; 4,980,463; 5,141,860; 4,807,100 and 4,920,209. However, such approaches typically yield Sucralose containing varying levels of other chlorinated sugar compounds in addition to Sucralose.

U.S. Pat. No. 5,270,460 and WO2005090374 disclose the process for purification of Sucralose by silicagel chromatography or other chromatographic methods. However, purification of Sucralose by chromatographic method is commercially not suitable and cumbersome at an industrial scale.

U.S. Pat. Nos. 4,801,700; 4,783,526; 5,141,860; 4,977,254 and GB2224504 disclose the process for purification of Sucralose by recrystallization from ethylacetate. This process provides Sucralose having some impurities which are difficult to remove even after repeated crystallization. This process provides Sucralose having purity of less than 99.6%. However, repeated crystallization would result in a loss of yield of the final product.

Another problem associated with purity and yield of Sucralose relates to the formation of a wide range of related chlorinated carbohydrates during Sucralose synthesis, which are only partially removed during purification. These related compounds, or impurities, have varying degrees of sweetness, and can interact with the flavor systems of food and beverage products in adverse ways. Various compendial sources, such as the Food and Drug Codex, the United States Pharmacopoeia, and Joint Expert Committee on Food Additives have established specifications for Sucralose. All of these authorities allow impurities in Sucralose of up to 2%. Individuals can detect sweetness differences arising from impurities when the impurity level is as low as about 1%, and even lower impurity levels can affect the perceived taste of complex flavor systems. Hence, chlorinated carbohydrates generated during Sucralose synthesis may have a profound effect on taste, affecting the quality of an end product. Conversely, the removal of impurities may beneficially affect taste, sweetness, and palatability.

U.S. Pat. No. 6,809,198 discloses a process for purification of Sucralose by crystallization from aqueous solution in controlled pH condition at pH 5.5 to 8.5 using buffer solution. This process requires regular monitoring of pH. It also requires special kind of industrial apparatus for the purification process. These drawbacks make the process cumbersome at an industrial scale.

U.S. Pat. Nos. 5,034,551 and 4,980,463, incorporated herein relates to a process in which the aqueous solution remaining after ester hydrolysis of Sucralose precursors is extracted three times with ethyl acetate to remove methyl benzoate, unreacted Sucralose-6-benzoate and other non-polar impurities. The aqueous layer was charcoalized and Sucralose was crystallized from the aqueous layer. The recovered crystals have a reported purity of 99.6%. Purification to this level is achieved primarily through crystallization, rather than by solvent extraction processes. However, this technique is less capable of removing polar impurities from impure Sucralose.

U.S. Pat. No. 5,498,709 also relates to a process in which the aqueous solution remaining after ester hydrolysis of Sucralose precursors is concentrated and then Sucralose is isolated by three sequential extractions with ethyl acetate or other suitable solvent. The extracts may then be combined, and optionally washed with water to remove any dimethylformamide remaining prior to recovering the Sucralose by concentration and crystallization. Sucralose is crystallized from the same solvent until the required purity is achieved. Alternatively, the Sucralose may be crystallized from a solvent mixture or water. The purity obtained by this method may also be less.

An additional approach discussed within U.S. Pat. No. 5,498,709, which is expressly incorporated by reference herein, involves the toluene extraction of the alkaline solution remaining after deesterification. Specifically, the solution is extracted twice with toluene to remove non-polar impurities. The aqueous solution is then extracted repeatedly with 2-butanone. The 2-butanone extracts are combined, and the solvent is evaporated to yield a reddish syrup containing Sucralose. Non-polar impurities are removed but still there is no effective manner disclosed to remove polar impurities. Hence, Sucralose prepared according to this process may have purity lower than 99.6%.

U.S. Pat. No. 7,049,435 discloses the process for purification of Sucralose by extractive method which involves repeated extraction from first solvent (i.e. water), second solvent (i.e. ethylacetate) and third solvent (i.e. ethylacetate). This process provides purification selecting two different solvents with polarity based on Hildebrand parameter.

This process also requires special kind of industrial apparatus to perform the purification. Moreover, this kind of process requires repeated extraction is tedious and laborious to perform.

All above references as mentioned hereinabove are incorporated in its entirety. The preceding discussion identifies an unmet need for a Sucralose purification process that produces Sucralose compositions of enhanced purity and also minimizes the overall loss of Sucralose during the purification process. Hence, a less expensive and more effective method is needed for the commercial production of Sucralose. The present inventions attempt to solve these problems and provide methodologies that are both commercially practicable and effective at removing impurities.

The present inventors have directed their research work towards developing an improved purification process which not only overcome the problems mentioned hereinabove but also provides Sucralose having purity of at least 99.6%. Surprisingly the present inventors found a process which provides Sucralose having purity of at least 99.6%.

### OBJECT OF THE INVENTION

A primary object of the present invention is to provide highly pure Sucralose having purity of at least 99.6%.

Another object of the present invention is to provide a process for the preparation of highly pure Sucralose having purity of at least 99.6%.

Another object of the present invention is to provide Sucralose having Organic Volatile Impurity (OVI) less than 100 parts per million (ppm).

Another object of the present invention is to provide Sucralose having chlorinated impurities less than 0.2%.

Yet another object of the present invention is to provide an improved a process for preparing Sucralose, which is simple, easy to handle and feasible at commercial scale.

### SUMMARY OF THE INVENTION

The present invention relates to a process for the preparation of highly pure Sucralose having purity of at least 99.6% comprising steps of
(i) dissolving substantially impure Sucralose in water
(ii) treating the solution obtained in step (i) with a partially water immiscible solvent
(iii) washing the said solvent phase obtained in step (ii) with an amount of water sufficient to remove polar impurities
(iv) crystallizing the product from partially water immiscible solvent
(v) recrystallizing the solid obtained in step (iv) from water.

Another embodiment of the present invention relates to optionally recycling of the Sucralose remaining in mother liquor obtained in step (v) i.e. after the recrystallization from water is extracted with a solvent and subsequently mixed with the solvent phase obtained in step (iii).

### BRIEF DESCRIPTION OF THE DRAWINGS

FIG. 1 depicts a flow diagram of the operations performed as per process of the present invention.

FIG. 2 depicts Chromatogram of Sucralose obtained by Gas Chromatography representing the purity of 99.88% of Sucralose obtained as per process of the present invention.

### DETAILED DESCRIPTION OF THE INVENTION

Accordingly, present invention provides a process for the preparation of highly pure Sucralose having purity of at least 99.6% comprising steps of
(i) dissolving substantially impure Sucralose in water
(ii) treating the solution obtained in step (i) with a partially water immiscible solvent
(iii) washing the said solvent phase obtained in step (ii) with an amount of water sufficient to remove polar impurities
(iv) crystallizing the product from partially water immiscible solvent
(v) recrystallizing the solid obtained in step (iv) from water.

In a preferred embodiment of the present invention, substantially impure Sucralose is dissolved in water to form an aqueous solution of Sucralose. This solution is treated with an excess amount of an organic solvent which is partially immiscible in water. The solvent phase is washed with an amount of water sufficient to remove polar impurities. The product obtained is crystallized from partially water immiscible solvent. The isolated product is recrystallized from water.

In another embodiment of the present invention, after obtaining Sucralose having purity of at least 99.6%, optionally the remaining residue in mother liquor in step (v) is extracted with a partially water immiscible solvent and subsequently mixed with the solvent phase obtained in step (iii).

“Crystallization” as used herein includes processes in which a solution is rendered saturated or supersaturated with respect to a dissolved component and the formation of crystals of this component is achieved. The initiation of crystal formation may be spontaneous, or it may require the addition of seed crystals. As used herein, crystallization or recrystallization also describes the situation in which a solid or liquid material is dissolved in a solvent to yield a solution which is then rendered saturated or supersaturated so as to obtain crystals. Also, included in the term crystallization are the ancillary processes of washing the crystals with one or more solvents, drying the crystals, and harvesting the final product so obtained.

The term “Treating” as used herein includes processes in which, suspending, extracting, dissolving, washing, mixing and refluxing of two components either solid, liquid or in a solution form takes place.

“Substantially impure Sucralose” refers to Sucralose having purity of less than 99.6% for the purpose of this specification.

“Highly pure Sucralose” refers to Sucralose having purity of at least 99.6% for the purpose of this specification.

The example of organic solvent includes but not limited to ethyl acetate, methylisobutyl ketone and the like or mixture thereof.

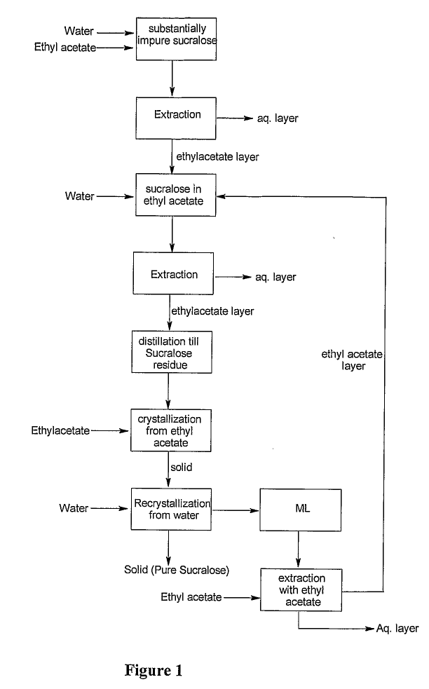

The schematic representation of the present invention is as shown in FIG. 1. The flow diagram of FIG. 1 discloses sequential step of the operations performed as per process of the present invention. This flow diagram also represents optionally recycling of the Sucralose remaining in mother liquor obtained in step (v) i.e. after the recrystallization from water, is extracted with a partially water immiscible solvent and subsequently mixed with the solvent phase obtained in step (iii).

Substantially impure Sucralose is prepared by methods known perse or by any method known to person skilled in art. The process for deacetylation step is disclosed in U.S. Pat. No. 4,801,700 in example XIII and in co-pending Indian application No. 0009/MUM/2006.

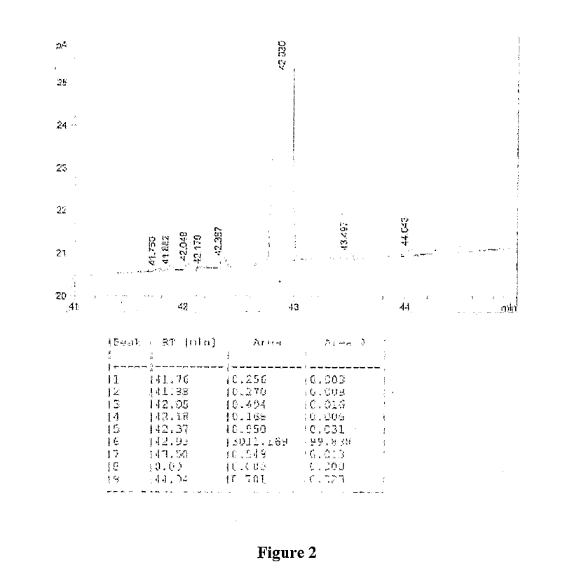

Sucralose obtained by performing purification mentioned in this application is having purity of at least 99.6%. FIG. 2 confirms the purity of 99.88% of Sucralose by Gas Chromatography. Sucralose obtained by performing purification mentioned in this application is having Organic Volatile Impurity (OVI) less than 100 parts per million (ppm) and chlorinated impurities less than 0.2%.

The process of the present invention is described by the following examples, which are illustrative only and should not be construed so as to limit the scope of the invention in any manner.

### Example-1

4,1′,6′-Trichloro-4,1′,6′-trideoxygalactosucrose pentaacetate (TOPSA) (100 g) was stirred at ambient temperature with sodium carbonate (1 gm) in methanol (1000 ml). Reaction was stirred for about 2 hours. The reaction mixture was neutralized. The solution was distilled to get thick residue. The residue was dissolved in D.M.Water (75 ml) and extracted with ethylacetate (500 ml). The ethyl acetate layer was separated and washed with D.M.Water (75 ml) and evaporated to dryness. The residue was dissolved in fresh ethyl acetate (300 ml) and allowed to stir for 5-20 hours. The precipitates obtained were filtered and dried. The solid was recrystallized form water and dried in oven to give solid (30 g) Sucralose.

The mother liquor obtained after recrystallization from water was extracted with ethylacetate and mixed with ethylacetate of the earlier stage (i.e. before water wash) of subsequent batch.

(Total yield: 70%; Purity by Gas Chromatography (GC)˜99.8%)

1. A process for the preparation of Sucralose having purity of at least 99.6% comprising steps of
(i) dissolving substantially impure Sucralose in water
(ii) treating the solution obtained in step (i) with a partially water immiscible solvent
(iii) washing the said solvent phase obtained in step (ii) with an amount of water sufficient to remove polar impurities
(iv) crystallizing the product from partially water immiscible solvent
(v) recrystallizing the solid obtained in step (iv) from water.

2. A process for the preparation of Sucralose having purity of at least 99.6% comprising steps of
(i) dissolving substantially impure Sucralose in water
(ii) treating the solution obtained in step (i) with a partially water immiscible solvent
(iii) washing the said solvent phase obtained in step (ii) with an amount of water sufficient to remove polar impurities
(iv) crystallizing the product from partially water immiscible solvent
(v) recrystallizing the solid obtained in step (iv) from water.
and optionally recycling of the Sucralose remaining in the residue in mother liquor obtained in step (v) is extracted with a partially water immiscible solvent and subsequently mixed with the solvent phase obtained in step (iii).

3. The process as claimed in claim 1, wherein partially water immiscible solvent is selected from the group comprising ethylacetate and methyl isobutylketone or mixture thereof.

4. Sucralose having purity of at least 99.8%

5. Sucralose having Organic Volatile Impurity (OVI) less than 100 parts per million (ppm).

6. Sucralose having chlorinated impurities less than 0.2%
